(19) United States
(12) Patent Application Publication
(10) Pub. No.: US 2013/0308912 A1
(43) Pub. Date: Nov. 21, 2013

(54) Blind Mate Optoelectronic Device

(71) Applicant: Aurora Networks, Santa Clara, CA (US)

(72) Inventors: Artie Avlonitis, San Jose, CA (US); Steve Hopkins, Union City, CA (US); Brian Ishaug, Pleasanton, CA (US); Zulfikar Morbi, San Jose, CA (US); Oleh Sniezko, Dillon, CO (US)

(73) Assignee: Aurora Networks, Santa Clara, CA (US)

(21) Appl. No.: 13/672,714

(22) Filed: Nov. 9, 2012

Related U.S. Application Data
(60) Provisional application No. 61/628,933, filed on Nov. 9, 2011.
(60) Provisional application No. 61/628,923, filed on Nov. 9, 2011.
(60) Provisional application No. 61/629,030, filed on Nov. 10, 2011.
(60) Provisional application No. 61/629,029, filed on Nov. 10, 2011.
(60) Provisional application No. 61/629,028, filed on Nov. 10, 2011.

(51) Int. Cl. G02B 6/36

(52) U.S. Cl. CPC G02B 6/36
USPC 385/88

(57) ABSTRACT

A method includes connecting a first end of an optoelectronic device with an electrical back plate including blind mating; and connecting a second end of the optoelectronic device with an optical back plate including blind mating. An apparatus includes an optoelectronic device including a first end having an electrical interface for blind mating and a second end having an optical interface for blind mating.

### CROSS-REFERENCES TO RELATED APPLICATION(S)

This application claims a benefit of priority under 35 U.S.C. 119(e) from copending provisional patent applications U.S. Ser. No. 61/628,933, filed Nov. 9, 2011, U.S. Ser. No. 61/628,923, filed Nov. 9, 2011, U.S. Ser. No. 61/629,030, filed Nov. 10, 2011, U.S. Ser. No. 61/629,029, filed Nov. 10, 2011 and U.S. Ser. No. 61/629,028, filed Nov. 10, 2011, the entire contents of all of which are hereby expressly incorporated herein by reference for all purposes.

### BACKGROUND

Broadband communication systems are complex systems with many factors to consider when designing RF circuits and connectors. Small form factor pluggable optical modules such as, but not limited to SFF, SFP, SFP+, XFP are designed to blind mate/plug in only the electrical interface while the optical interface is left open. The installer (e.g. CATV operator) must manually mate each optical connector to this exposed optical interface side with fiber optical cables protruding out.

### SUMMARY

There is a need for the following embodiments of the present disclosure. Of course, the present disclosure is not limited to these embodiments.

According to an embodiment of the present disclosure, a process comprises: connecting a first end of an optoelectronic device with an electrical back plate including blind mating; and connecting a second end of the optoelectronic device with an optical back plate including blind mating. According to another embodiment of the present disclosure, a machine comprises: an optoelectronic device including a first end having an electrical interface for blind mating and a second end having an optical interface for blind mating. These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements). The described embodiments may be better understood by reference to one or more of these drawings in combination with the following description presented herein. It should be noted that the features illustrated in the drawings are not necessarily drawn to scale.

FIG. 1 is an isometric view of an electronic interface end of an optoelectronic device, representing an embodiment of the present disclosure.

FIG. 2 is side view of the optoelectronic device of FIG. 1.

FIG. 3 is an isometric view of an optical interface end of the optoelectronic device of FIGS. 1-2.

FIGS. 4A-4B are cross-sectional and end views of the optoelectronic device of FIGS. 1-3.

FIG. 5 is another isometric view of the optical interface end of the optoelectronic device of FIGS. 1-4.

FIGS. 6A-6B are top assembled (6A) and top disassembled (6B) views of the optoelectronic device of FIGS. 1-5 in association with an optical interface (plate and/or plane), representing an embodiment of the invention.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well known signal processing techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

Embodiments of the invention relate to transmission of analog and/or digital signals over fiber optics. More specifically, some embodiments of the invention relate to small form factor pluggable modules for transmission systems such as, but not limited to, CATV systems. The disclosure of this application is marginally related to copending U.S. Ser. No(s)._(attorney docket number AUROR1350-1), filed Nov. 9, 2012,_(attorney docket number AUROR1370-1), filed Nov. 9, 2012,_(attorney docket number AUROR1380-1), filed Nov. 9, 2012,_(attorney docket number AUROR1390-1), filed Nov. 9, 2012, the entire contents of all of which are hereby expressly incorporated by reference for all purposes.

Embodiments of the invention enable blind mating of both optical and electronics sides of an optoelectronic device. This means embodiments of the invention can include an optoelectronic device for optical and/or electrical blind mating on a first and/or a second side (end).

Embodiments of the invention enable the optical interface of an optoelectronic device to also be blind mateable so that an optoelectronic device can blind-mate interface with an optical back plate (plane), as well as blind mate with an electrical back plate (plane). Embodiments of the invention provide an important commercial advantage in that without embodiments of the invention, in the context of a(n) (partially) installed system, the installer and/or end user (CATV operator) must manually mate the optical connector to this exposed side with fiber optical cables protruding out.

In this design scenario with embodiments of the invention, all the optical connectors can be configured and routed into an optical housing with all the fiber connections done internally. Embodiments of the invention provide another important commercial advantage in that In the case of transmitter failure, the (e.g. small form factor pluggable) optoelectronic device can be easily removed and replaced without interrupting the other devices in the system.

Embodiments of the invention can include a plurality of optical connections. Embodiments of the invention can include a plurality of electronic connections.

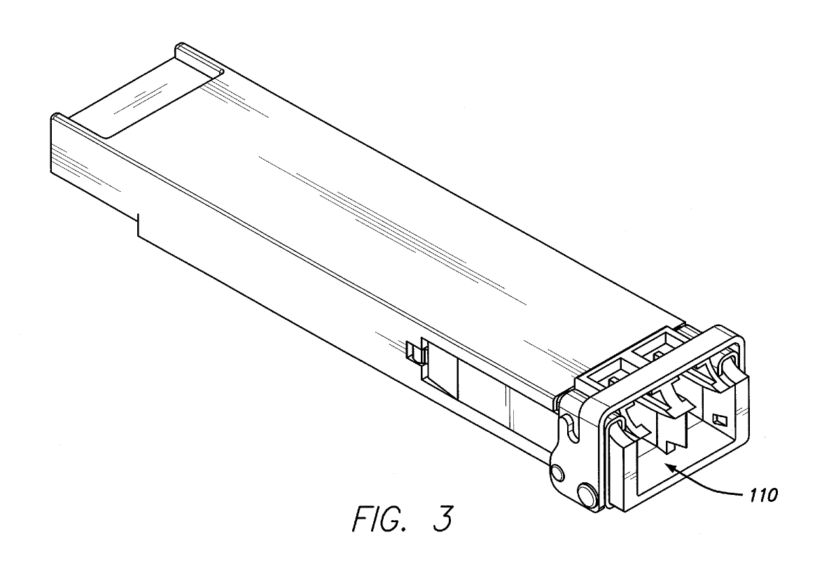

Referring to FIGS. 3-5, embodiments of the invention can include a substantial angle on optical interface to allow for blind mating. Such an angle can be defined by a chamfered entry for blind mate applications located on the optical end of the optoelectronic device. Similarly, embodiments of the invention can include a substantial angle on electronic interface to allow for blind mating. Such an angle can be defined by a chamfered entry for blind mate applications located on the electronic end of the optoelectronic device.

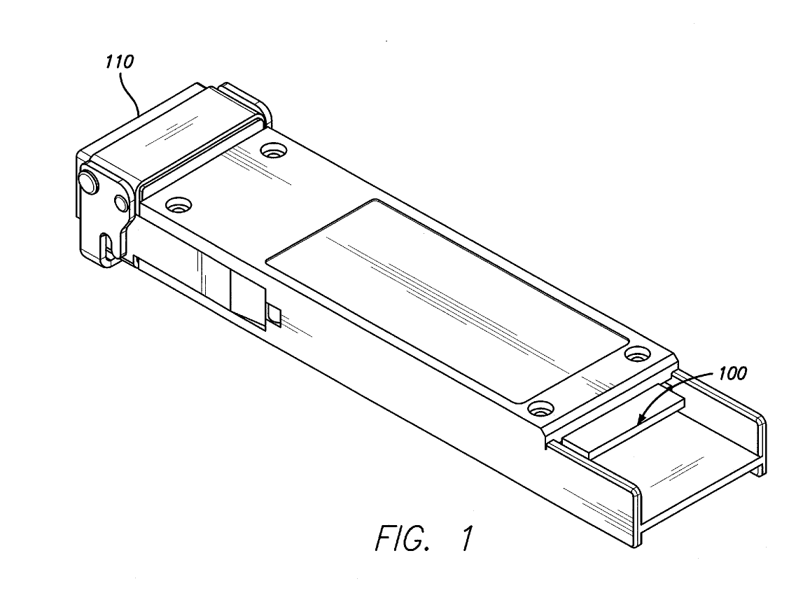

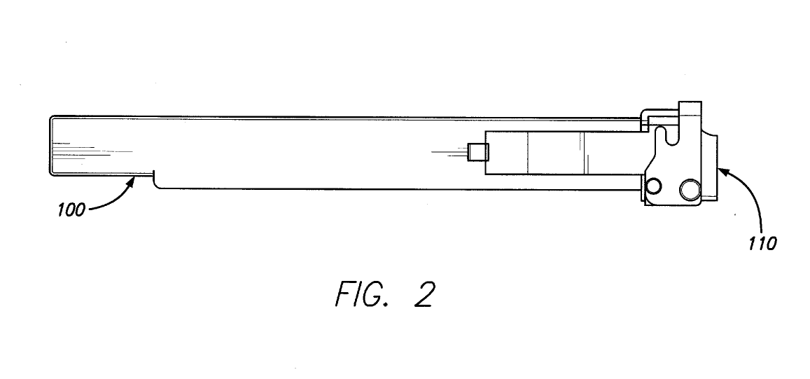

Referring to FIGS. 1-2, an optoelectronic device includes a first end having an electrical interface 100 for blind mating and a second end having an optical interface 110 also for blind mating. Referring to FIG. 1, the electrical interface includes an alignment entry channel 120.

Referring to FIG. 3, the optical interface 110 includes a latching connector. Embodiment of the invention can include an optical interface that includes, but is not limited to, LC (latching connector), SC (snap connector), MPO (multiple port/position optic). Embodiments of the invention can include an electronic interface that includes, but is not limited to, SFP (small form factor pluggable), XFP (form factor pluggable).

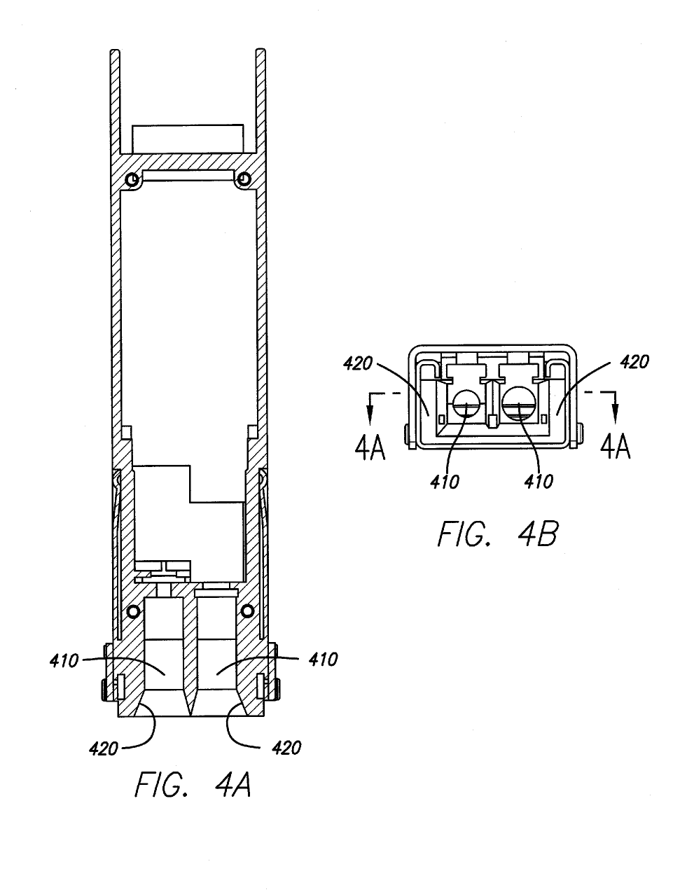

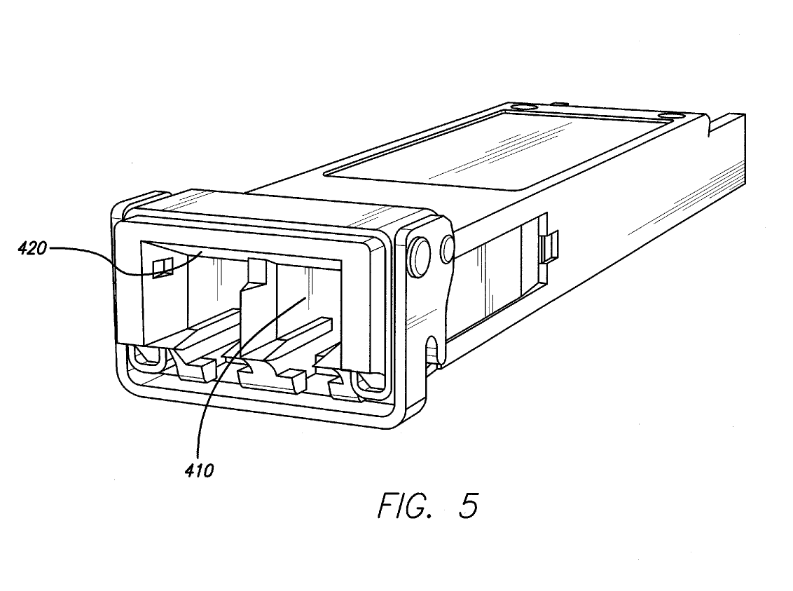

Referring to FIGS. 4A-4B and 5, the optical interface defines a plurality of lumen 410. In this example, the lumen is by a latching connector. Alternatively the lumen could be defined by a snap connector or a multiple port/position optic. Still referring to FIGS. 4A-4B and 5, the lumen defines a chamfered entry 420 for blind mate applications. In this example, the chambered entry is substantially 4-fold symmetric with regard to a principal axis defined by the lumen.

Still referring to FIGS. 4A-4B and 5, the optical interface includes a plurality of lumen 410 each of which defines a chamfered entry 420 for blind mate applications. In this example, each chamfered entry is substantially 4-fold symmetric. In this example, the plurality of lumen define a plural of principal axes that are substantially coplanar.

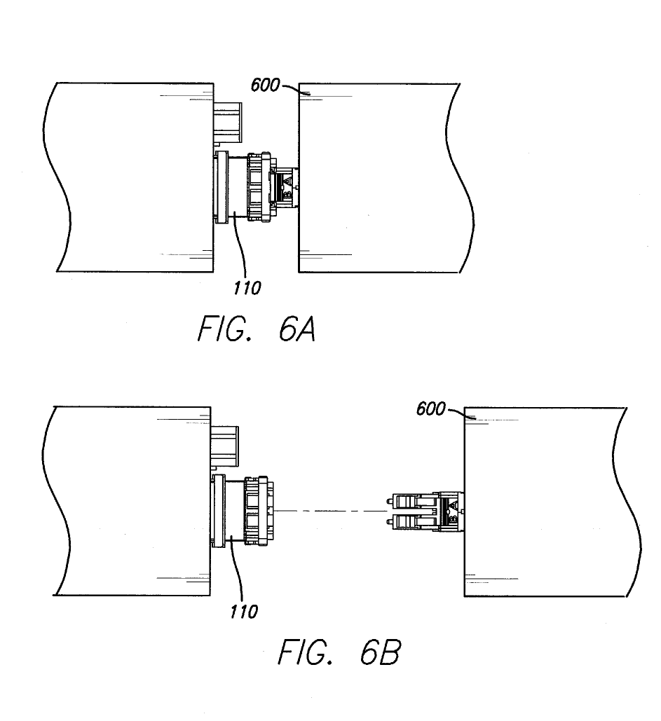

Referring to FIGS. 6A-6B, the optoelectronic device is shown in an assembly on the left. An optical back plate 600 is shown on the left.

### Definitions

The term lumen is intended to mean an inner open space or cavity of a tubular structure, as of a latching connector or of a snap connector or of a multiple port/position optic, having one or more of a circular, square, polyhedral or other cross sectional shape. The term chamfered is intended to mean a substantial angle (e.g. at least approximately)10° relative to an axis, such as a central axis of a lumen. The phrase blind mating is intended to mean aligning while the distance between two subassemblies is reduced until assembly is completed, without the electrical or optical connection points being visible. The phrase radio frequency (RF) is intended to mean frequencies less than or equal to approximately 300 GHz as well as the infrared spectrum.

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be combined in the disclosed configurations, but could be combined in any and all configurations.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
connecting a first end of an optoelectronic device with an electrical back plate including blind mating; and
connecting a second end of the optoelectronic device with an optical back plate including blind mating.

2. The method of claim 1, wherein blind mating the second end includes aligning a principal axis defined by a lumen defined by the optoelectronic device with the optical back plate by moving the optoelectronic device.

3. The method of claim 2, wherein aligning includes
reversibly moving the optoelectronic device substantially orthogonally with regard to a principal axis that is normal to a plane defined by the optical back plate and
pushing a 4-fold symmetric chamfered entry on the optoelectronic device onto the optical back plate.

4. The method of claim 1, wherein blind mating the second end includes aligning the optical back plate with a principal axis defined by a lumen defined by the optoelectronic device by moving the optical interface.

5. The method of claim 4, wherein aligning includes
reversibly moving the optical back plate substantially orthogonally with regard to the principal axis defined by the lumen defined by the optoelectronic device and
pushing the optical back plate into a 4-fold symmetric chamfered entry on the optoelectronic device.

6. An apparatus, comprising an optoelectronic device including a first end having an electrical interface for blind mating and a second end having an optical interface for blind mating.

7. The apparatus of claim, wherein the optical interface defines a lumen.

8. The apparatus of claim, wherein the lumen is defined by one member selected from the group consisting of a latching connector, a snap connector or a multiple port/position optic.

9. The apparatus of claim, wherein the lumen defines a chamfered entry for blind mate applications.

10. The apparatus of claim, wherein the chambered entry is substantially 4-fold symmetric with regard to a principal axis defined by the lumen.

11. The apparatus of claim, wherein the optical interface includes a plurality of lumen each of which defines a chamfered entry for blind mate applications.

12. The apparatus of claim , wherein each chamfered entry is substantially 4-fold symmetric.

13. The apparatus of claim, wherein the plurality of lumen define a plural of principal axes that are substantially coplanar.

14. The apparatus of claim, wherein the electrical interface includes an alignment entry channel.
